(19) United States
(12) Patent Application Publication
(10) Pub. No.: US 2026/0365284 A1
(43) Pub. Date: Nov. 19, 2026

(54) PARALLEL MOORING LINES TO SAME ANCHOR

(71) Applicant: Grant Prideco, Inc., Wilmington, DE (US)

(72) Inventor: Geir Olav Hovde, His (NO)

(21) Appl. No.: 19/478,233

(22) PCT Filed: Mar. 19, 2024
(86) PCT No.: PCT/NO2024/050071

§ 371 Date: Oct. 23, 2025

(30) Foreign Application Priority Data
Apr. 24, 2023 (NO) 20230444

(51) Int. Cl. B63B 21/50; B63B 21/20; B63B 21/26; B63B 35/44

(52) U.S. Cl. CPC B63B 21/50; B63B 21/20; B63B 21/26; B63B 35/44; B63B 2021/203; B63B 2035/446

(57) ABSTRACT

A mooring arrangement for mooring a floating unit to the seabed, the mooring arrangement includes multiple mooring clusters each connectable to a floating unit and an anchor adapted for the seabed, wherein at least one mooring cluster comprises at least two mooring lines.

### TECHNICAL FIELD

The present disclosure relates to offshore mooring arrangements, systems and methods. More specifically it relates to a mooring arrangement where parallel or nearly parallel mooring lines are connectable to the same floating unit at one end and to the same anchor on the seabed at the other end.

### BACKGROUND

Renewable energy has a growing interest in the industry. For offshore energy harvesting main focus today is on wind energy, where wind turbines are placed on either bottom-fixed structures or on moored floating units. To obtain enough capacity of produced energy several of these structures/units are installed in the same area and connected together forming a wind farm/park.

Cost for these offshore farms, and especially farms comprising moored floating units, is in general higher than onshore farms. To secure that offshore wind farms comprising moored floating units are competitive the technology must be optimized. This involves cost reduction in all areas, including cost for goods, cost for transport and cost for offshore installation.

A moored floating device has typically three or more mooring lines, where each mooring line is connected to the floating unit at one end and to an anchor at the other end. The floating units in a farm do not typically share mooring lines and/or anchors, which means that a farm of N floating units has N·M mooring lines and N·M anchors, where M is the number of mooring lines per floating unit. In a farm the floating units can however be arranged in such a way that anchors are shared between the floating units. Examples of such prior art arrangements are illustrated in FIGS. 3-5. As seen the total number of anchors is significantly reduced compared to an arrangement where only individual anchors are used. Reduced number of anchors reduces cost for hardware, cost for transport and cost for offshore installation.

With a continuously increase in size of the floating wind turbines the mooring line components such as chain, steel wire rope, synthetic ropes, etc. are getting close to, or above, the manufacturing limitations at the supplier's facilities. To solve this the number of mooring lines connected to each floater needs to increase. Drawback is however that the number of anchors, which contributes significantly to the overall cost of the mooring system, also increases.

Examples of prior arts related to shared anchors or shared mooring lines are disclosed in patent documents U.S. Pat. No. 3,082,608A, NO325261B1, CA2637358A1, CA2725808A1, U.S. Pat. No. 8,657,534B2, JP2011245879A, CN102715107A, U.S. Pat. No. 9,567,040B2, CN111071400A, WO2021078748A1, WO2022013145A1 and WO2022098288A1.

These prior arts refer mainly to shared anchors or shared mooring lines between neighbor floating units (also referred to as “floaters”), and not to shared anchors between mooring lines from the same floater. U.S. Pat. No. 3,082,608A and NO325261B1 includes a mooring line bridle arrangement towards the floating unit, which are connected together at a distance from the floater and then further connected to at least one anchor. The separation angle between the two bridle arms is however much larger than in the present disclosure since the purpose of the bridle is to limit the yaw motion of the floating unit and not to reduce the individual mooring line loads. In U.S. Pat. No. 9,567,040B2 the mooring lines are fully vertical with the objective to reduce the floater heave, pitch and roll motion, which is different from the disclosure herein. U.S. Pat. No. 8,657,534B2 and JP2011245879A have mooring lines which are slightly inclined relative the vertical axis with the objective to limit the surge, sway and yaw (especially) motion of the floater. These lines are further combined with separate heave limiting devices, and thus different from the present disclosure. Furthermore, documents U.S. Pat. No. 3,082,608A, U.S. Pat. No. 8,657,534B2, JP2011245879A and NO325261B1 discloses that multiple mooring line bridles are connected to shared connections points on the floating unit.

In difference to U.S. Pat. No. 3,082,608A, U.S. Pat. No. 8,657,534B2, JP2011245879A and U.S. Pat. No. 9,567,040B2 the present disclosure has small or negligible effect on the floater heave, pitch and roll motion since the horizontal distance between the lower end and upper end of the mooring line is equal to or larger than the vertical distance between the line ends, i.e. the angle B in FIG. 14 is less than 45 degrees.

An object of the present disclosure is to overcome the drawbacks of the known prior art and to provide a mooring arrangement where several of the mooring lines from the same floater are arranged in parallel, or nearly parallel, and connected to the same anchor on the seabed.

To achieve these objectives, a system and method according to the independent claims are provided.

### SUMMARY

The disclosure is set forth and characterized in the main claims, while the dependent claims describe other characteristics of the disclosure.

In a first aspect of the disclosure, the disclosure relates to a mooring arrangement for mooring a floating unit to the seabed, the mooring arrangement comprises multiple mooring clusters each connectable to a floating unit and an anchor adapted for the seabed, wherein at least one mooring cluster comprises at least two mooring lines, wherein the at least two mooring lines of the same mooring cluster are adapted to be connected to the same anchor.

In an embodiment of the first aspect of the disclosure, the disclosure relates to at least two mooring lines each comprises a floating unit connection point adapted to be connected to the floating unit, wherein the floating unit connection points are spaced less than 30 meters horizontally apart.

In another embodiment of the first aspect of the disclosure, the disclosure relates to the mooring lines within the same mooring cluster are individual lines and separate along their length and comprises separate anchor connection points at the anchor end and separate floating unit connection points at the floating unit end.

In yet another embodiment of the first aspect of the disclosure, the disclosure relates to the mooring lines within the same mooring cluster are connected together at a connection element located between the anchor and the floating unit.

In yet another embodiment of the first aspect of the disclosure, the disclosure relates to a single mooring line between the anchor connection point and the connection element, and where the length of the single mooring line and the connection element is less than 50% of the distance between the anchor connection point and the floating unit connection points on the floating unit.

In yet another embodiment of the first aspect of the disclosure, the disclosure relates to at least two mooring clusters, wherein each mooring cluster comprises two mooring lines connectable to a common anchor, wherein a first mooring cluster comprises a first set of floating unit connection points connectable to a floating unit, and a second mooring cluster comprises a second set of floating unit connection points connectable to the floating unit, wherein the location of the first set of floating unit connection points differs from the second set of floating unit connection points on the floating unit, so that none

In yet another embodiment of the first aspect of the disclosure, the disclosure relates to the at least two mooring lines each comprises a floating unit connection point adapted to be connected to the floating unit, wherein the two floating unit connection point are separated by a first distance D1, and; wherein the horizontal distance between any of the anchor connection points of the at least two mooring lines associated with the anchor and any of the floating unit connection points defines a second distance D2, wherein the ratio given by the second distance divided by the first distance D2/D1 is greater than 5.

In yet another embodiment of the first aspect of the disclosure, the disclosure relates to the arrangement comprising a separation angle A less than 5 degrees, wherein A is defined as the angle between the a first line 14 and second line 15 that reflects the straight lines, in the horizontal plane, between anchor connection point and floating unit connection point for the two outermost mooring lines of the mooring cluster.

In yet another embodiment of the first aspect of the disclosure, the disclosure relates to the arrangement comprising an angle B less than 45 degrees, wherein the angle B is defined by the angle between an horizontal axis, and an straight line between the lower and upper end of mooring line.

In another aspect of the disclosure, the disclosure relates to a mooring system for mooring a floating unit to the seabed, the mooring system comprises at least one mooring arrangement according to the first aspect, and at least one floating unit and at least one anchor.

In an embodiment of the second aspect of the disclosure, the disclosure relates to at least two mooring clusters, wherein each mooring cluster comprises two mooring lines connected to a common anchor, wherein a first mooring cluster comprises a first set of floating unit connection points connected to the floating unit, and a second mooring cluster comprises a second set of floating unit connection points connected to the floating unit, wherein the location of the first set of floating unit connection points differs from the second set of floating unit connection points, on the floating unit, so that none of the connections points coincides.

In an another embodiment of the second aspect of the disclosure, the disclosure relates to the floating unit comprises at least two structurally connected floating elements, wherein each mooring cluster is associated with respective floating elements of the floating unit.

In yet another embodiment of the second aspect of the disclosure, the disclosure relates to a horizontal distance between the anchor connection points of the at least two mooring lines associated with the anchor and the floating unit connection points associated with the floating unit is larger than 150 meters.

In yet another embodiment of the second aspect of the disclosure, the disclosure relates to the angle between a vector, the vector being defined by a straight line between the anchor connection point and the floater connection point, and a projected vector representing the projection of the vector down on the seabed, is less than 45 degrees.

In yet another embodiment of the second aspect of the disclosure, the disclosure relates to the at least two mooring lines each comprises a floating unit connection point connected to the floating unit, wherein the two floating unit connection point are separated by a first distance D1, and wherein the horizontal distance between any of the anchor connection points of the at least two mooring lines connected with the anchor and any of the floating unit connection points defines a second distance D2, wherein the ratio given by the second distance divided by the first distance D2/D1 is greater than 5.

In yet another embodiment of the second aspect of the disclosure, the disclosure relates to the mooring cluster comprises a separation angle A less than 5 degrees, wherein A is defined as the angle between the a first line 14 and second line 15 that reflects straight lines, in the horizontal plane, between anchor connection point and floating unit connection point for the two outermost mooring lines of the mooring cluster.

In yet another embodiment of the second aspect of the disclosure, the disclosure relates to the arrangement comprises an angle B less than 45 degrees, wherein the angle B is defined by the angle between an horizontal axis, and an straight line between the lower and upper end of mooring line.

In yet another embodiment of the second aspect of the disclosure, the disclosure relates to the floating unit being a floating wind turbine.

In yet another embodiment of the second aspect of the disclosure, the disclosure relates to the floating unit being a unit for oil and gas applications or other energy related applications.

In yet another embodiment of the second aspect of the disclosure, the disclosure relates to the floating unit being a semi-submersible, ship-shaped or barge type unit.

In yet another embodiment of the second aspect of the disclosure, the disclosure relates to the mooring lines within the same mooring cluster are identical in composition and length.

In yet another embodiment of the second aspect of the disclosure, the disclosure relates to the mooring lines within the same mooring cluster are different in composition and length.

In yet another embodiment of the second aspect of the disclosure, the disclosure relates to the anchor shared by mooring lines from the same mooring cluster of the same floating unit is also shared with mooring lines from other floating units.

In a third embodiment of the disclosure, the disclosure relates to the mooring lines within the same mooring cluster are installed in parallel and simultaneously between the anchor and the floating unit.

In a forth embodiment of the disclosure, the disclosure relates to the use of the first and/or second embodiment to moor floating units.

### BRIEF DESCRIPTION OF THE FIGURES

Below, various embodiments of the disclosure will be described with reference to the figures, in which

FIG. 1 illustrates a typical general arrangement of a moored unit/floater with its mooring lines, perspective view

FIG. 2 illustrates a typical general arrangement of a moored unit/floater with its mooring lines, seen from the side

FIG. 3 illustrates a mooring arrangement for multiple floaters (24 off), where each floater is moored with 3 mooring lines, and where several anchors are shared between the floaters

FIG. 4 illustrates a mooring arrangement for multiple floaters (20 off), where each floater is moored with 4 mooring lines, and where several anchors are shared between the floaters

FIG. 5 illustrates a mooring arrangement for multiple floaters (24 off), where each floater is moored with 6 mooring lines, and where several anchors are shared between the floaters

FIG. 6 illustrates a typical composition of a mooring leg

FIG. 7 illustrates a typical composition of a mooring leg with buoyancy element

FIG. 8 illustrates a mooring layout for a floater with 8 mooring lines and 4 anchors, where the lines connected to the same anchor are nearly parallel

FIG. 9 illustrates a mooring layout for a floater with 8 mooring lines and 4 anchors, where the lines connected to the same anchor are parallel

FIG. 10 illustrates a mooring layout for a floater with 6 mooring lines and 3 anchors, where the lines connected to the same anchor are separated with an angle A, seen from above

FIG. 11 illustrates a mooring layout for a floater with 6 mooring lines and 3 anchors, where the lines connected to the same anchor are connected together at a point between the anchor and the floater, seen from above

FIG. 12 illustrates a mooring layout for a floater with 6 mooring lines and 3 anchors, where the lower part of the lines in the mooring cluster are connected together at a distance from the anchor giving a common anchor connection point, seen from above

FIG. 13 illustrates the same as FIG. 10 but shows all lines and anchors

FIG. 14 illustrates a mooring layout for a floater, seen from the side

FIG. 15 illustrates an illustration of the footprint of a typical floating unit

### DETAILED DESCRIPTION

Preferred embodiments of the disclosure are described below with reference to the attached figures. The following description will use terms such as “horizontal”, “vertical”, “lateral”, “back and forth”, “up and down”, “upper”, “lower”, “inner”, “outer”, “forward”, “rear”, etc. The longitudinal direction is defined as the direction along a central axis. These terms generally refer to the views and orientations as shown in the drawings and that are associated with a normal use of the disclosure. The terms are used for the reader's convenience only and shall not be limiting. Like numerals on different drawings describe the same feature. Numerals with apostrophe represents an additional feature represented by the same numeral, for instance the number 4 will represent one or the first of multiple or all of the multiples, and the numeral 4′ represents an additional or a further of the same feature, like a second or multiple of the same feature.

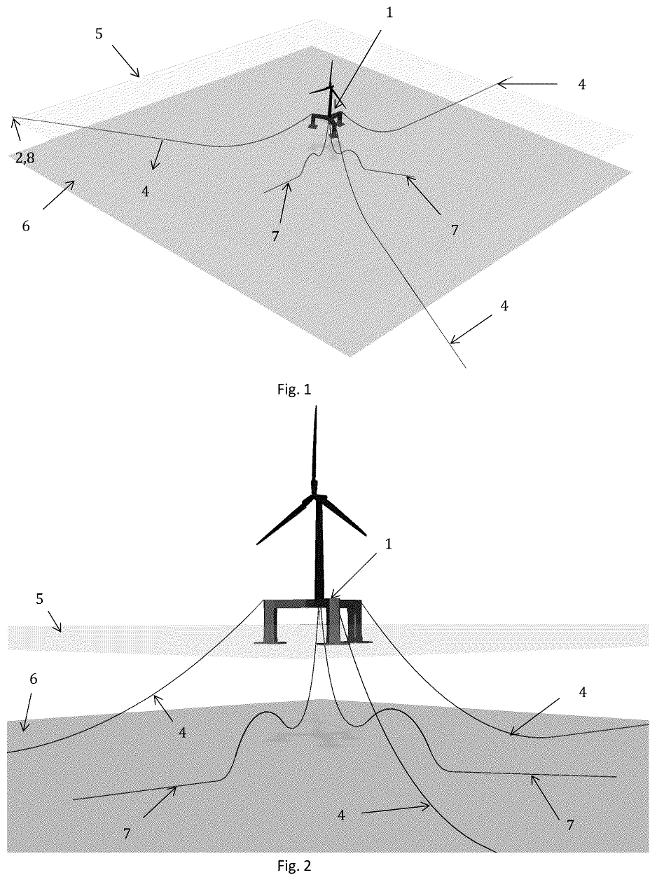

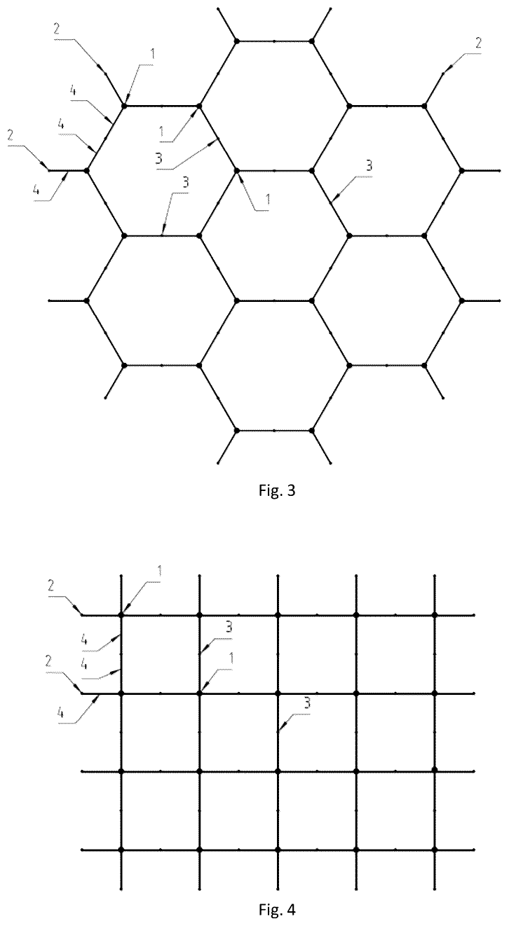

FIGS. 1-2 illustrates an overall view of a typical mooring system arrangement previously known for floating wind turbines. In this illustration the floating unit 1 at the sea surface 5 is moored to the seabed 6 with mooring lines 4 connected to the floating unit 1 at the upper end and to an individual anchor 2 at the lower end.

Main purpose of the mooring system is to hold the floating wind turbine 1 within a certain excursion boundary when subject to environmental loads such as wind, wave and current. The excursion boundary is on the other hand determined by the excursion capacity of the power cables 7. In another example the power cables can be fluid lines or control lines, and the floating unit can be any type of units moored to the seabed within mooring lines 4. Other types of floating units can be semi-submersible platforms, SPAR platforms, ship-shaped units or barges for oil & gas or energy industry, such as floating production and storage units, floating storage units, floating liquified natural gas production vessel, floating storage and re-gasification units, floating nuclear power plants, floating gas power stations, etc..

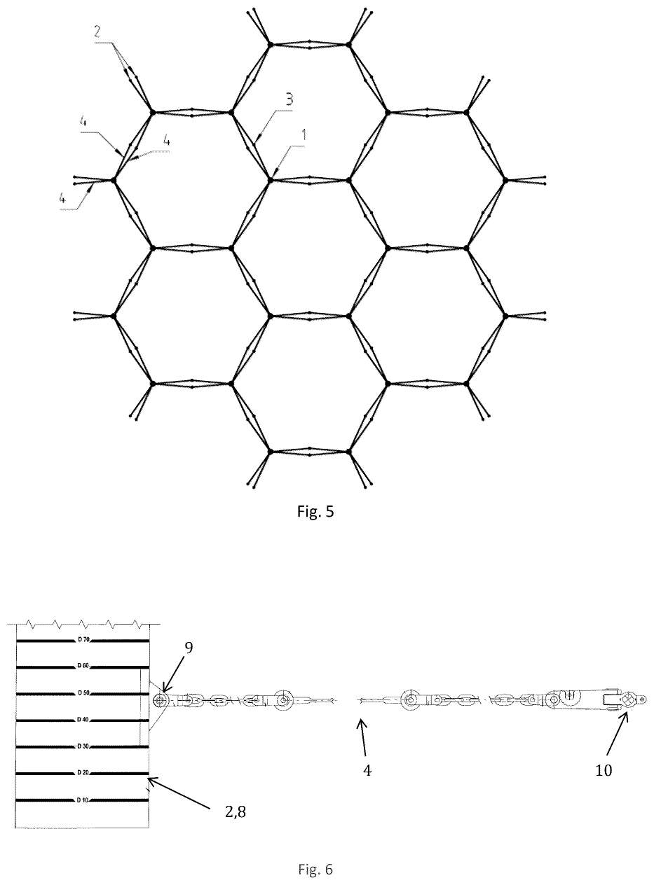

FIGS. 3-5 present various examples where floating units 1, in for instance a wind farm, share the same anchors 3. The anchors shown in FIG. 1 are not individual anchors, but anchors where mooring lines 4 from several floating units are connected. At the outer boundaries of the wind farm the anchors 2 are connected to only one floating unit, but for anchors inside the wind farm several floater units are connected to the same anchor 3.

FIG. 6 illustrated a typical arrangement of a mooring leg. The mooring leg comprises an individual anchor 2 and a mooring line 4. The mooring line 4 is in this embodiment connected to the anchor connection 9 at one end and connected to the floater connection 10 at the other end. The mooring line can be assembled in a variety of combinations, comprising e.g. chain, steel wire rope, synthetic ropes, buoys, clump weights, shackles, H-links, Y-links, mooring connectors, mooring tensioners, etc..

The mooring line in FIG. 6 comprises an H-link towards the anchor, a lower chain segment, a second H-link, a synthetic rope segment, a third H-link, an upper chain segment, and a mooring connector towards the floating unit.

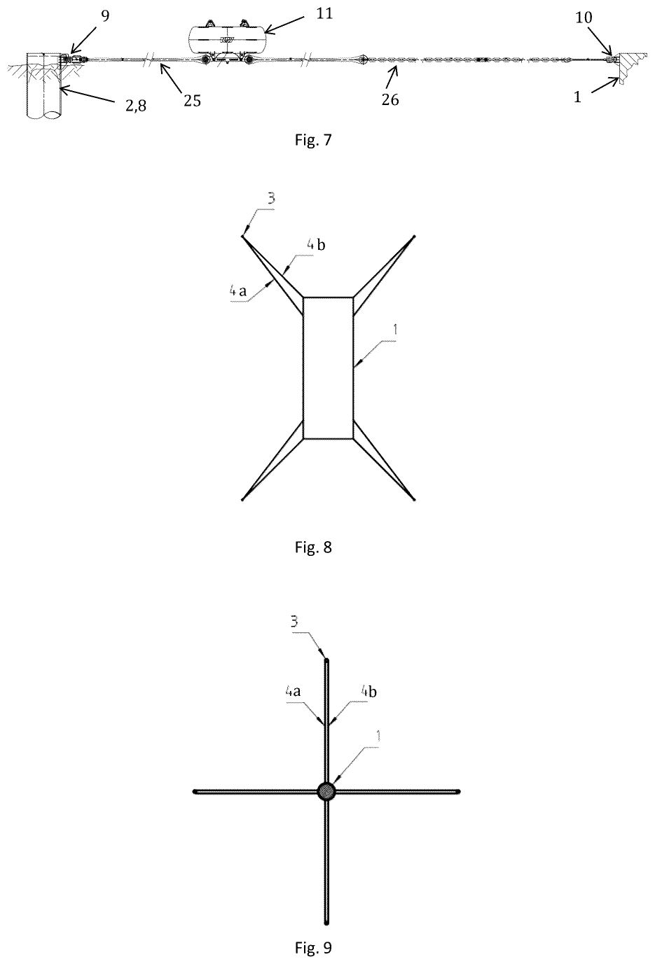

FIG. 7 illustrates another typical mooring line composition, which includes a buoy 11 between the lower part 25 of the mooring line 4 and the upper part 26 of the mooring line 4.

FIG. 8 illustrates an embodiment of the disclosure where the mooring system comprises eight mooring lines 4 configured in four mooring clusters with two mooring lines 4a, 4b in each cluster. A mooring cluster can thereby be considered a pair, or more lines, going from a common anchor 3 to substantially the same part of the floater. A common anchor 3 should be understood as the one and the same anchor. Substantially the same part of the floater can be considered the same part, such as a single structural entity, such as a pontoon, leg, structure, deck, floating device, or where structures are not easily distinguishable, within a distance of 30 meter. The two lines in each cluster are connected to the same anchor 3 and are arranged nearly parallel between the floating unit 1 and the anchor 3. Although the figure does not illustrate perfectly parallel relations between the two mooring lines, it should be understood that these figures are not in perfect dimensions, and with an increasing distance between the anchor 3 and the floating unit 1, the lines will diverge towards parallel relations, i.e. nearly parallel. The largest separation between the two lines is at the connection towards the floating unit 1.

FIG. 9 illustrates another embodiment of the disclosure where four mooring clusters are configured to moor one floating unit 1, where two mooring lines 4a, 4b in each of the four mooring clusters are arranged perfectly parallel between the floating unit 1 and the anchor 3.

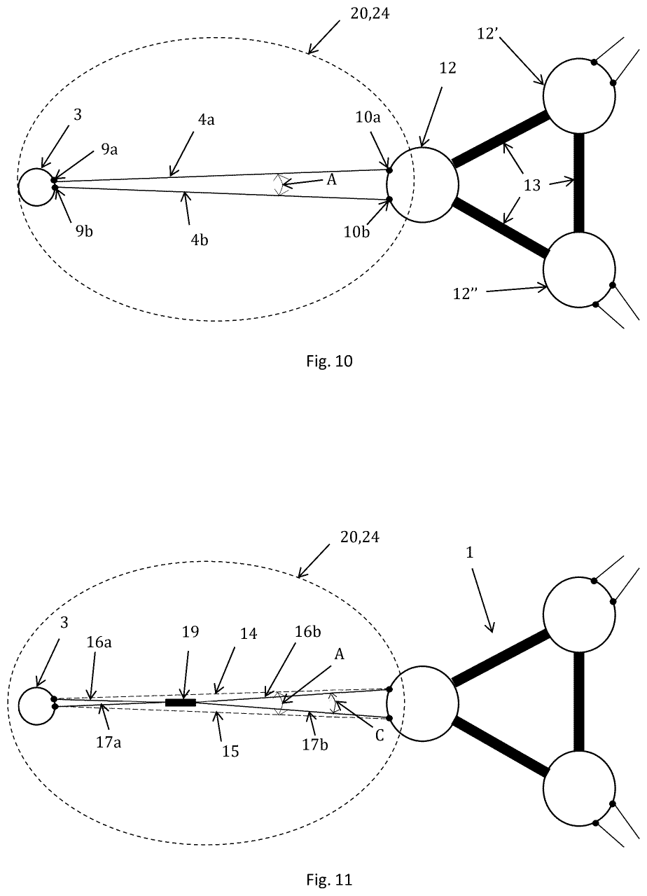

FIG. 10 illustrates a mooring arrangement 20 in connection with a semi-submersible type of floating unit 1. The mooring arrangement comprises multiple mooring clusters 24, wherein each mooring cluster is connectable to the floating unit 1 and the anchor 3. Wherein the anchor 3 is adapted for installment or to be embedded in the seabed 6. Each mooring cluster comprises at least two mooring lines 4a, 4b, wherein the mooring arrangement is configured such that the at least two mooring lines 4a, 4b of the same mooring cluster are adapted to be connected to the same anchor 3. The disclosure also relates to a mooring system 20, wherein multiple mooring clusters 24 are connected to respective anchors and the floating unit 1, wherein each mooring cluster is connected to the floating unit 1 and the anchor 3. Wherein the anchor 3 is embedded or anchored in the seabed 6, and wherein each mooring cluster comprises at least two mooring lines 4a, 4b, wherein the at least two mooring lines 4a, 4b of the same mooring cluster 24 connected to the same anchor 3.

In FIG. 10 and FIG. 13, the disclosure is illustrated in relation to a semi-submersible type floater, exemplified in this figure with three buoyancy columns 12, 12′, 12″, which are interconnected with bracings 13. The mooring system 20 comprises six mooring lines arranged in three mooring clusters 24, where each cluster contains two mooring lines 4a, 4b. The two mooring lines within each cluster are connected to the same buoyancy column 12 at connection points 10 a and 10 b, respectively. At the other end the two mooring lines are connected to the same anchor at connection points 9a and 9b, respectively. Since the buoyancy column 12, 12′, 12″ has limited dimensions the separation angle A may typically be less than 4-5 degrees. The separation angle A refers to the separation angle of the two mooring lines 4a, 4b in the same mooring cluster in the horizontal plane, i.e. of the projection of the mooring arrangement and/or mooring lines 4a, 4b onto the sea surface (or seabed). In the illustrated example the floating unit 1 comprises three structurally connected floating elements 12, 12′, 12″, wherein each mooring cluster is associated with respective floating elements 12, 12′, 12″ of the floating unit 1.

The horizontal distance between connection points 10a and 10b will preferably be 5-10 m, such that a dropped object from a position close to the floating unit is unlikely to damage both mooring lines (large separation preferred) but also give limited load skewness between the two lines (small separation preferred). For a semi-submersible type of floating unit the practical upper horizontal separation limit between connections 10a and 10b may preferably be 25-30 m. A separation angle A of 5 degrees combined with a horizontal separation of 30 m between connections 10a and 10b will then imply a horizontal distance between the anchor connection point 9 and floater connection point 10 of 340 m, while with 3 degrees separation angle A and 10 m between connections 10a and 10b the horizontal distance between anchor connection point 9 and floater connection point 10 will be 190 m. Further, in another example, 1.7 degrees separation angle A combined with 30 m horizontal separation between 10a and 10b implies 1000 m between anchor and floater connection points. For all practical purposes the horizontal distance between the anchor connection point 9 and the floater connection point 10 will be larger than 150 m.

It is also beneficial with a horizontal separation distance between the connections 10a and 10b during hook-up of the second mooring line of the mooring cluster, because this will reduce the risk for damaging the already installed first mooring line.

The dimension of the anchor 3 is generally smaller than the buoyancy column 12. The horizontal separation distance between connection point 9a and 9b on the anchor will therefore typically be smaller, in the order of 1-3 m, than at the floater end between 10a and 10b. The anchor connection point 9 may also be a single point.

To avoid skewed loads the mooring lines 4 in the same mooring cluster may be identical in length and composition and fully parallel. Then these lines will experience the same loads. However, identical load history may be a drawback since failure in one of these lines due to an unforeseen failure mode may lead to failure in the neighbor line(s) as well. For instance, identical lines and identical load history implies also identical fatigue lives and risk for simultaneous fatigue failures. Hence, it may be preferable to design the parallel or nearly parallel mooring lines in the same cluster slightly different, such that there is a difference in the load history. After failure in the most critical mooring line the other lines can then provide sufficient rest-capacity (e.g. fatigue life) to obtain sufficient time for repair without any additional failures. The difference in load history can be obtained by using a separation angle A larger than 0 degrees, different line lengths, different line compositions providing different line stiffnesses and weight distributions, or a combination thereof.

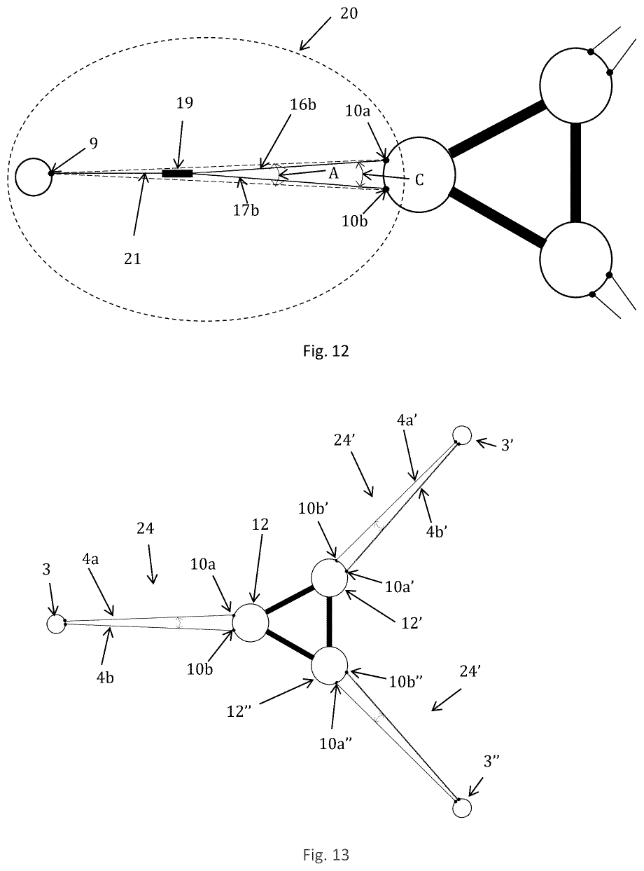

FIG. 11 illustrates another example, where the mooring lines 4a, 4b in the same mooring cluster is connected together at one or several points by a connection element 19 between the anchor connection point 9 and the floating unit connection point 10. This connection element 19 can for instance be a buoy 11 as shown in FIG. 7. It can also be a clump weight, a mooring line tensioning device, a triplate, or any other structural component. In this set-up the separation angle A is defined as the angle between the imaginary lines 14 and 15, illustrated by the dotted lines in FIGS. 11 and 12. These lines reflect the straight line, in the horizontal plane, between anchor connection point 9 and floating unit connection point 10 for the two outermost mooring lines of the mooring cluster. An outermost mooring line 16 is in this example defined as the lower section 16a between the anchor 3 and the connection element 19, and the upper section 16b between the connection element 19 and the floating unit 1. An outermost mooring line 17 is in this embodiment defined as the lower section 17a between the anchor 3 and the connection element 19, and the upper section 17b between the connection element 19 and the floating unit 1.

In another example the lines 16a and 17a between the anchor 3 and the connection element 19, as shown in FIG. 11, can be achieved with one single line. This is illustrated in FIG. 12, where lines 16a and 17a are collected into one single line segment 21 connected to a single anchor point 9 at one end and to the connection element 19 at the other end. To reduce the risk that this single line 21 is the weakest point it can be given a higher strength than the lines 16b and 17b together. Further, to reduce the risk for external damage on line 21 the length of line 21 should be shorter than the overall length of the mooring line 4. Preferably the length of line 21 plus the length of the connection element 19 should be less than 30-50% of the nominal distance between the anchor connection point 9 and the floating unit connection points 10a,10b. This should be understood such that that the separation angle C (in the horizontal plane, i.e. in the projection of the arrangement onto the sea surface or seabed) between lines 16b and 17b is less than 8-10 degrees since the separation angle A is less than 4-5 degrees (see above). For a fully horizontal mooring arrangement, i.e. the mooring lines 4 have an inclination angle of 90 degrees relative the vertical axis, the separation angle between lines 16b and 17b in their combined plane (i.e. the plane of the bridle defined by lines 16b and 17b) is also less than 8-10 degrees. However, if the mooring line arrangement is inclined 45 degrees relative the vertical axis, then the separation angle between lines 16b and 17b (in the plane of the bridle) is 5.7-7.1 deg, i.e. significantly below the angle range 20-60 deg described in U.S. Pat. No. 325,261B1.

FIG. 13 illustrates an example wherein the mooring arrangement comprises at least two mooring clusters. The specific illustration illustrates three mooring clusters 24, 24′, 24″ wherein each mooring cluster comprises two mooring lines 4a, 4b connectable to a respective anchor 3, 3′, 3′. In said example, each mooring cluster is connectable to the floating unit 1 and an anchor 3 adapted for the seabed 6. Each mooring cluster may also be connectable to different sections 12, 12′, 12″ of the mooring unit 1. In another embodiment, the disclosure relates to a mooring system comprising at least two mooring clusters 24, 24′, 24″, and wherein each mooring cluster comprises two mooring lines 4a, 4b connected to respective anchor 3, 3′, 3″, each mooring cluster is connected to the floating unit 1 and an anchor 3 embedded in the seabed 6. Each mooring cluster may also be connectable to different sections 12, 12′, 12″ of the mooring unit 1. Although the illustration in FIG. 13 only discloses three mooring clusters 24, 24′, 24″, it should be understood that the disclosure can comprise to any number of mooring clusters, such as 1, 2, 3, 4, 5 . . .

FIG. 13 further illustrates a first mooring cluster 24 comprising a first set of floating unit connection points 10a, 10b connectable, or connected, to a floating unit 1, or to different sections 12, 12′, 12″ of the mooring unit 1, and a second mooring cluster 24′ comprising a second set of floating unit connection points 10a′, 10b′ connectable, or connected, to the floating unit 1, or to different sections 12, 12′, 12″ of the mooring unit 1. In the illustrated example the location of the first set of floating unit connection points 10a, 10b differs from the second set of floating unit connection points 10a′, 10b′, on the floating unit, so that none of the connections points are shared. In the illustrated example, all connection points between a mooring line and the floating unit 1, or parts thereof, are unique in the way that they do not coincide.

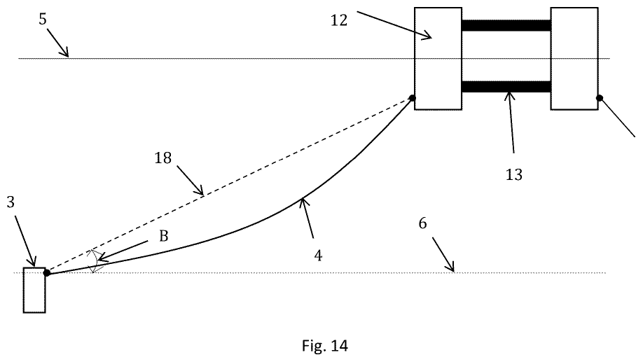

The disclosure may relate to a catenary mooring system, or a semi-taut type or taut mooring system. The mooring arrangement or system shall mainly restrict the floating unit in the horizontal plane, i.e. surge, sway and yaw motions. Effect on heave, pitch and roll motions are limited. This means that the mooring lines shall be arranged mainly in the horizontal direction, implying that the vertical distance between the lower and upper end of the mooring line 4 is smaller than the horizontal distance between the lower and upper end of the mooring line 4. This means that the angle B in FIG. 14 is less than 45 degrees. Angle B is the angle between the horizontal axis, herein exemplified with the seabed 6, and the imaginary straight line 18 (or vector) between the lower and upper end of mooring line 4, when looking at the mooring line from the side. The horizontal axis is the vector on the seabed obtained by projecting the vector 18 from the 3-dimensional space down onto the 2-dimensional seabed.

Angle A, angle B, angle C and other dimensions, refer to the nominal scenario, i.e. the floating unit (1) is in equilibrium position without any exposure to wind, wave and current and other external forces.

The disclosure may relate to a mooring arrangement 20 or system, wherein the at least two mooring lines 4a, 4b each comprises a floating unit connection point 10, 10a, 10b connected, or connectable, to the floating unit 1, wherein the two floating unit connection point 10, 10a, 10b are separated by a first distance D1 when connected to the floating unit 1, and
wherein the horizontal distance D2 between any of the anchor connection points 9, 9a, 9b of the at least two mooring lines 4a, 4b associated with the anchor 3 and any of the floating unit connection points 10, 10a, 10b defines a second distance D2, wherein the ratio given by the second distance divided by the first distance D2/D1 is greater than 5. For instance if the anchor connection points 9, 9a, 9b and the floating unit connection point 10, 10a, 10b are separated by the distance D2=150, the maximum separation between the two outer floating unit connection points 10a, 10b can be D1=30 meters, as D2/D1= 150/30=5.

The disclosure may relate to a mooring arrangement 20 or system, wherein, wherein the arrangement comprises a separation angle A less than 5 degrees, wherein A is defined as the angle between the a first line 14 and second line 15 that reflects the straight lines, in the horizontal plane, between anchor connection point 9, 9a, 9b and floating unit connection point 10, 10a, 10b for the two outermost mooring lines of the mooring cluster. The separation angle A may be 5 degrees or less, or 4 degrees or less, or 1,7 degrees or less.

The disclosure may relate to a mooring arrangement 20 or system, wherein the arrangement comprises an angle B less than 45 degrees, wherein the angle B is defined by the angle between an horizontal axis, and an straight line 18 between the lower and upper end of mooring line 4a, 4b, 4a′, 4b′.

The disclosure can also be combined with anchor sharing between different floating units 1 as illustrated in FIGS. 3-5, such that one anchor 3 is attached to two or more mooring clusters in turn connectable, or connected to, two or more floating units. In said example, the disclosure may relate to a mooring system for mooring two or more floating units 1 to the seabed 6, wherein the mooring system comprises at least two mooring clusters 24, each connectable, or connected, with at least two mooring lines 4a, 4b, wherein, the at least two mooring clusters 24 are connectable, or connected, to an anchor 3.

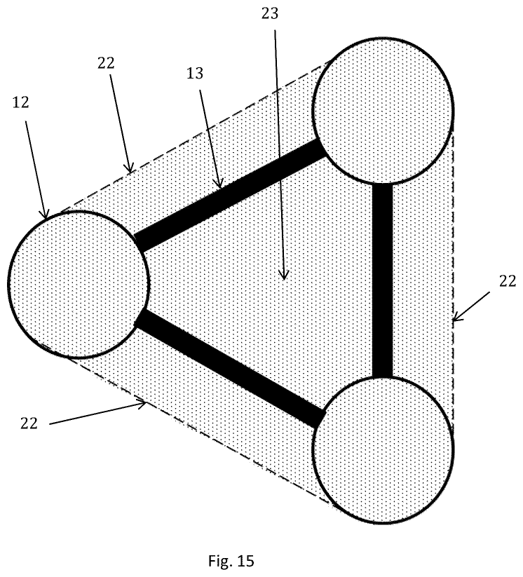

The typical floating unit 1 has a footprint in the water line larger than 1000-1500 m². The footprint is herein defined as the closed area inside an imaginary tight rope sling around the outermost points of the floating unit 1 in the water line 5. The footprint is in FIG. 15 exemplified for a semi-submersible floating unit (1) as the shaded area 23, which is the area circumference by the imaginary rope sling 22. The outermost points are in this example the buoyancy columns 12. The bracings 14 are for the illustrated semi-submersible in FIG. 15 not any outermost points.

With parallel or nearly parallel mooring lines 4, which are connected to the same anchor 3, it is possible to the install the mooring lines 4 simultaneously. After anchor installation, all lines to be connected to the same anchor 3 can be connected to the anchor at connection 9, 9a, 9b before the installation vessel lays/pre-lays the mooring lines 4 in parallel at the same time, starting at the anchor end and ending at the floater end.

Although specific embodiments of the disclosure have been described and illustrated herein, it is recognized that modifications and variations may readily occur to those skilled in the art, and consequently, it is intended that the claims be interpreted to cover such modifications and equivalents. For instance, the disclosure is not limited to two mooring lines 4 within each mooring cluster, but to at least two mooring lines between the boundary limits defined by angle A and angle C.

### REFERENCE NUMERALS

1 Moored floater
2 Anchor for single mooring line
3 for several mooring lines
4 Mooring line or part of mooring line
5 Sea surface
6 Seabed (also denoted mudline or sea floor)
7 Fluid line, control line and/or power line
8 Anchor in general
9 Mooring line connection to anchor
10 Mooring line connection point to moored floater
11 Buoyancy element
12 Floater buoyancy column
13 Floater bracing
14 Straight line between anchor connection and floater connection seen from above for outermost mooring line at side 1 of mooring cluster
15 Straight line between anchor connection and floater connection seen from above for outermost mooring line at side 2 of mooring cluster
16 Outermost mooring line (or part thereof) of parallel or nearly parallel mooring lines, side 1 of mooring cluster
17 Outermost mooring line (or part thereof) of parallel or nearly parallel mooring lines, side 2 of mooring cluster
18 Straight line between anchor connection and floater connection seen from the side
19 Device for mutual connection of parallel or nearly parallel mooring lines between anchor connection and floater connection
20 Mooring arrangement
21 Single mooring line section
22 Imaginary rope sling around the outermost points of the floating unit
23 Area inside the boundary defined by the imaginary rope sling
24 Mooring cluster
25 Lower part of mooring line
26 Upper part of mooring line

1. Mooring arrangement (20) for mooring a floating unit (1) to the seabed (6), the mooring arrangement comprises multiple mooring clusters each connectable to a floating unit (1) and an anchor (3) adapted for the seabed (6), wherein at least one mooring cluster comprises at least two mooring lines (4a, 4b),
wherein the mooring arrangement is characterized by the at least two mooring lines (4a, 4b) of the same mooring cluster are adapted to be connected to the same anchor (3).

2. The mooring arrangement (20) according to claim 1, wherein the at least two mooring lines (4a, 4b) each comprises a floating unit connection point (10,10a, 10b) adapted to be connected to the floating unit (1), wherein the floating unit connection points (10,10a,10b) are spaced less than 30 meters horizontally apart.

3. Mooring arrangement (20) according to claim 1 or 2, wherein the mooring lines (4a, 4b) within the same mooring cluster are individual lines and separate along their length and comprises separate anchor connection points (9a, 9b) at the anchor (3) end and separate floating unit connection points (10a, 10b) at the floating unit (1) end.

4. The mooring arrangement (20) according to claim 1 or 2, wherein the mooring lines (4a, 4b) within the same mooring cluster are connected together at a connection element (19) located between the anchor (3) and the floating unit (1).

5. The mooring arrangement (20) according to claim 4, wherein the arrangement further comprises a single mooring line (21) between the anchor connection point (9) and the connection element (19), and where the length of the single mooring line (21) and the connection element (19) is less than 50% of the distance between the anchor connection point (9) and the floating unit connection points (10,10a, 10b) on the floating unit (1).

6. The mooring arrangement according to any one of the previous claims, wherein the arrangement comprises at least two mooring clusters, wherein each mooring cluster comprises two mooring lines (4a, 4b, 4a′, 4b′) connectable to a common anchor (3), wherein a first mooring cluster (24) comprises a first set of floating unit connection points (10a, 10b) connectable to a floating unit (1), and a second mooring cluster (24′) comprises a second set of floating unit connection points (10a′, 10b′) connectable to the floating unit (1), wherein the location of the first set of floating unit connection points (10a, 10b) differs from the second set of floating unit connection points (10a′, 10b′) on the floating unit (1), so that none of the connections points coincides.

7. The mooring arrangement (20) according to any one of the preceding claims, wherein the at least two mooring lines (4a, 4b) each comprises a floating unit connection point (10, 10a, 10b) adapted to be connected to the floating unit (1), wherein the two floating unit connection point (10, 10a, 10b) are separated by a first distance D1, and;
wherein the horizontal distance between any of the anchor connection points (9, 9a, 9b) of the at least two mooring lines (4a, 4b) associated with the anchor (3) and any of the floating unit connection points (10, 10a, 10b) defines a second distance D2,
wherein the ratio given by the second distance divided by the first distance D2/D1 is greater than 5.

8. The mooring arrangement (20) according to any one of the preceding claims, wherein the arrangement comprises a separation angle A less than 5 degrees, wherein A is defined as the angle between the a first line 14 and second line 15 that reflects the straight lines, in the horizontal plane, between anchor connection point (9, 9a, 9b) and floating unit connection point (10, 10a, 10b) for the two outermost mooring lines of the mooring cluster.

9. The mooring arrangement (20) according to any one of the preceding claims, wherein the arrangement comprises an angle B less than 45 degrees, wherein the angle B is defined by the angle between an horizontal axis, and an straight line (18) between the lower and upper end of mooring line (4a, 4b, 4a′, 4b′).

10. A mooring system for mooring a floating unit (1) to the seabed (6), the mooring system comprises;
a mooring arrangement according to any one of the claims 1-6.
a floating unit (1)
an anchor (3).

11. The mooring system according to claim 10, wherein the system comprises at least two mooring clusters, wherein each mooring cluster comprises two mooring lines (4a, 4b) connected to a common anchor (3), wherein a first mooring cluster (24) comprises a first set of floating unit connection points (10a, 10b) connected to the floating unit (1), and a second mooring cluster (24′) comprises a second set of floating unit connection points (10a′, 10b′) connected to the floating unit (1), wherein the location of the first set of floating unit connection points (10a, 10b) differs from the second set of floating unit connection points (10a′, 10b′), on the floating unit, so that none of the connections points coincides.

12. The mooring system according to claim 10 or 11, wherein the floating unit comprises at least two structurally connected floating elements (12, 12′, 12″), wherein each mooring cluster (24, 24′, 24″) is associated with respective floating elements (12, 12′, 12″) of the floating unit (1).

13. The mooring system according to any of the claims 10-12, wherein the horizontal distance between the anchor connection points (9, 9a, 9b) of the at least two mooring lines (4a, 4b) associated with the anchor (3) and the floating unit connection points (10, 10a, 10b) associated with the floating unit (1) is larger than 150 meters.

14. The mooring system according to any of the claims 10-13, wherein the angle between an vector (18), the vector being defined by a straight line between the anchor connection point (9,9a,9b) and the floater connection point (10,10a,10b), and a projected vector representing the projection of the vector (18) down on the seabed (6), is less than 45 degrees.

15. The mooring system according to any one of claims 10-14, wherein the at least two mooring lines (4a, 4b) each comprises a floating unit connection point (10, 10a, 10b) connected to the floating unit (1), wherein the two floating unit connection point (10, 10a, 10b) are separated by a first distance D1, and;
wherein the horizontal distance between any of the anchor connection points (9, 9a, 9b) of the at least two mooring lines (4a, 4b) connected with the anchor (3) and any of the floating unit connection points (10, 10a, 10b) defines a second distance D2,
wherein the ratio given by the second distance divided by the first distance D2/D1 is greater than 5.

16. The mooring system according to any one of claims 10-15, wherein the mooring cluster comprises a separation angle A less than 5 degrees, wherein A is defined as the angle between the a first line 14 and second line 15 that reflects straight lines, in the horizontal plane, between anchor connection point (9, 9a, 9b) and floating unit connection point (10, 10a, 10b) for the two outermost mooring lines of the mooring cluster.

17. The mooring system according to any one of claims 10-15, wherein the arrangement comprises an angle B less than 45 degrees, wherein the angle B is defined by the angle between an horizontal axis, and an straight line (18) between the lower and upper end of mooring line (4a, 4b, 4a′, 4b′).

18. The mooring system according to any of the claims 10-17, wherein the floating unit (1) is a floating wind turbine.

19. The mooring system according to any of the claims 10-18, wherein the floating unit (1) is a unit for oil and gas applications or other energy related applications.

20. The mooring system according to any of the claims 10-19, wherein the floating unit (1) is a semi-submersible, ship-shaped or barge type unit.

21. The mooring system according to any of the claims 10-20, wherein the mooring lines (4a, 4b) within the same mooring cluster are identical in composition and length.

22. The mooring system according to any of the claims 10-21, wherein the mooring lines (4) within the same mooring cluster are different in composition and length.

23. The mooring system according to any of the claims 10-22, wherein the anchor (3) shared by mooring lines (4a, 4b) from the same mooring cluster of the same floating unit (1) is also shared with mooring lines (4) from other floating units (1).

24. Method for installing a mooring arrangement according to claims 1-9, or a mooring system according to claims 10-23,
wherein the mooring lines (4a, 4b) within the same mooring cluster are installed in parallel and simultaneously between the anchor (3) and the floating unit (1).
